(19) United States
(12) Patent Application Publication
(10) Pub. No.: US 2026/0128482 A1
(43) Pub. Date: May 7, 2026

(54) FUSE TAB AND SECONDARY BATTERY INCLUDING THE FUSE TAB

(71) Applicant: SAMSUNG SDI CO., LTD., Yongin-si (KR)

(72) Inventors: Dae Kyu KIM, Yongin-si (KR); Kwangsoo SEO, Yongin-si (KR); Geunho SEO, Yongin-si (KR); Shinjung KIM, Yongin-si (KR); Jongjun PARK, Yongin-si (KR)

(21) Appl. No.: 19/274,827

(22) Filed: Jul. 21, 2025

(30) Foreign Application Priority Data
Nov. 6, 2024 (KR) 10-2024-0156542

(51) Int. Cl. H01M 50/583; H01H 85/02; H01H 85/08; H01M 50/107; H01M 50/152; H01M 50/474

(52) U.S. Cl. CPC H01M 50/583; H01H 85/0241; H01H 85/08; H01M 50/107; H01M 50/152; H01M 50/474; H01M 2200/103

(57) ABSTRACT

The present disclosure relates to a fuse tab and a secondary battery including the same. A fuse tab includes a pair of first metal foils, a second metal foil disposed located between the first metal foils, a wire electrically connecting the first metal foils and disposed located on the first metal foils and the second metal foil, and an insulating member insulating the first metal foils and the second metal foil and insulating the wire and the second metal foil, wherein a material of the first metal foils is different from a material of the second metal foil, a material of the wire is different from the material of the second metal foil, and a coefficient of thermal expansion (CTE) of the second metal foil is larger than a coefficient of thermal expansion of the wire.

### CROSS-REFERENCE TO RELATED APPLICATIONS

This present application claims priority to and the benefit under 35 U.S.C. § 119(a)-(d) of Korean Patent Application No. 10-2024-0156542, filed on Nov. 6, 2024, in the Korean Intellectual Property Office, the entire disclosure of which is incorporated herein by reference.

### BACKGROUND

### 1. Field

The present disclosure relates to a fuse tab and a secondary battery including the fuse tab.

### 2. Description of Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries have various protective devices that detect and cut off an overcurrent occurring inside the battery. Commonly used protective devices include components that perform a fuse function of cutting off a circuit when a current exceeds a certain limit to prevent overheating and damage to the battery. The protective device may include a metal conductor. When an excessive current flows, the conductor melts and the current is cut off. As a result, damage to the battery may be prevented.

Alternatively, a positive temperature coefficient (PTC) element may be used as a component performing the fuse function. The PTC element cuts off a flow of the current by rapidly increasing a resistance when a temperature or a current becomes abnormally high. Alternatively, a battery management system (BMS) for a high-capacity battery used in an electric vehicle or a large electronic device may detect and adjust an overcurrent and a temperature change of a battery in real time.

As the size of a lead tab or an electrode tab connected to an electrode assembly has increased, it is desirable for the fuse function to be implemented in the lead tab or the electrode tab itself.

The above information disclosed in this Background section is for enhancement of understanding of the background of the present disclosure, and therefore, it may contain information that does not constitute related (or prior) art.

### SUMMARY

An object of the present disclosure is to provide a fuse tab and a secondary battery including the fuse tab that may solve the above-described problems.

However, the technical problem to be solved by the present disclosure is not limited to the above problems, and other problems not mentioned herein, and aspects and features of the present disclosure that would address such problems, will be clearly understood by those skilled in the art from the description of the present disclosure below.

According to one or more embodiments of the present disclosure, a fuse tab includes a pair of first metal foils, a second metal foil disposed located between the first metal foils, a wire electrically connecting the first metal foils and disposed located on the first metal foils and the second metal foil, and an insulating member insulating between the first metal foils and the second metal foil and insulating between the wire and the second metal foil, wherein a material of the first metal foils is different from a material of the second metal foil, a material of the wire is different from the material of the second metal foil, and a coefficient of thermal expansion of the second metal foil is greater than a coefficient of thermal expansion of the wire.

In an embodiment, the wire may be located along a longitudinal direction of the fuse tab, and may be coupled to the first metal foils at opposite ends of the wire in a longitudinal direction.

In an embodiment, the fust tab is configured such that when a current flowing along the wire is greater than or equal to a threshold value, the second metal foil may thermally expand in a longitudinal direction of the fuse tab to thereby break the wire.

In an embodiment, a width of the wire may be less than a width of the fuse tab.

In an embodiment, the wire may include a first coupling portion, a second coupling portion, and a connecting portion connecting the first coupling portion and the second coupling portion, the first coupling portion and the second coupling portion are coupled to the first metal foils, and the connecting portion is provided on the second metal foil, and a width of the connecting portion is less than a width of the first coupling portion or the second coupling portion.

In an embodiment, the wire may include first wires and second wires with widths of the first wires being different than widths of the second wires, a width of the second wire is less than a width of the first wire, and the first wires and the second wires alternate in a longitudinal direction of the wire, and one of the first wires are provided at ends of the wire in the longitudinal direction.

In an embodiment, the insulating member may include first insulating members positioned between the first metal foil and the second metal foil, and a second insulating member positioned between the wire and the second metal foil, and a width of the second insulating member is greater than a width of the wire.

In an embodiment, the insulating member may include a first insulating member coated between the first metal foils and the second metal foil, and a second insulating member coated to surround the wire, and the second insulating member around a circumference of the wire that is located on the second metal foil.

In an embodiment, the fuse tab may further include a third metal foil coupled to a lower end of the second metal foil, wherein a coefficient of thermal expansion of the third metal foil is greater than a coefficient of thermal expansion of the second metal foil.

In an embodiment, the fuse tab is configured such that when a current flowing along the wire is greater than or equal to a threshold value, the third metal foil may thermally expands in a longitudinal direction of the fuse tab to thereby break the wire.

According to one or more embodiments of the present disclosure, a secondary battery includes an electrode assembly comprising a first electrode, a second electrode, and a separator interposed between the first electrode and the second electrode, a can accommodating the electrode assembly and having an open end, a cap assembly sealing the open end of the can, a first lead tab connected to the first electrode of the electrode assembly and coupled to the cap assembly, a second lead tab connected to the second electrode of the electrode assembly, and a fuse tab provided in the middle of the first lead tab, wherein the fuse tab includes a pair of first metal foils, a second metal foil located between the first metal foils, a wire electrically connecting the first metal foils and located on the first metal foils and the second metal foil, and an insulating member insulating between the first metal foils and the second metal foil and insulating between the wire and the second metal foil, a material of the first metal foils is different from a material of the second metal foil, a material of the wire is different from a material of the second metal foil, and a coefficient of thermal expansion of the second metal foil is greater than a coefficient of thermal expansion of the wire.

In an embodiment, the wire may be located along a longitudinal direction of the fuse tab, and be coupled to the first metal foils at opposite ends of the wire in a longitudinal direction.

In an embodiment, the fust tab is configured such that when a current flowing along the wire is greater than a threshold value, the second metal foil may thermally expand in a length direction of the fuse tab to thereby cut the wire.

In an embodiment, the first lead tab may be bent and mounted to an upper side of the electrode assembly, and the fuse tab may be positioned on the electrode assembly.

In an embodiment, the secondary battery may further include an insulating plate located between a portion of the first lead tab mounted on the upper side of the electrode assembly and the electrode assembly, wherein an end of the first lead tab is connected to a lower end of the cap assembly.

In an embodiment, the fuse tab is configured such that when a current flowing along the wire and the first metal foils is greater than a threshold value, the second metal foil may thermally expand in a longitudinal direction of the fuse tab due to heat transferred from the wire and the first metal foils.

In an embodiment, the second metal foil may be configured to expand in the longitudinal direction of the fuse tab at a temperature of 120° C. to 400° C.

In an embodiment, the first metal foils may include aluminum, stainless steel, iron, or a combination thereof.

In an embodiment, the second metal foil may include zinc, lead, magnesium, or a combination thereof.

In an embodiment, the secondary battery may be a cylindrical battery.

According to some embodiments of the present disclosure, when the overcurrent flows along the wire, a thermally expandable metal in contact with the wire expands, and thus, the wire is broken. As a result, the supply of the overcurrent can be cut off.

According to some embodiments of the present disclosure, when the secondary battery is manufactured, the sizes of the thermally expandable metal and the wire may be adjusted to adjust a breaking time of the wire according to temperature. As a result, a degree of freedom of design can be improved.

According to some embodiments of the present disclosure, a risk of thermal runaway and fire caused by the overcurrent in the secondary battery can be reduced.

According to some embodiments of the present disclosure, a metal element is designed to expand in response to heat generated by an overcurrent. This expansion generates a mechanical force that physically breaks a conductive member, such as a wire. As a result, the disconnection of the conductive path occurs promptly and consistently in response to the overcurrent, thereby reducing variation in the timing of electrical cut-off and improving the overall reliability of the fuse function.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of a part of a secondary battery according to an embodiment of the present disclosure.

FIG. 2 is a longitudinal sectional view of a secondary battery according to an embodiment of the present disclosure before a cap assembly is assembled.

FIG. 3 is a schematic top view of the fuse tab according to an embodiment of the present disclosure.

FIG. 4 illustrates a position of an insulating member according to the embodiment shown in FIG. 3.

FIG. 5 illustrates a fuse activation procedure of the fuse tab according to an embodiment of the present disclosure.

FIG. 6 are top views of fuse tabs according to embodiments of the present disclosure.

FIGS. 7 and 8 are schematic top views of a fuse tab according to an embodiment of the present disclosure.

FIG. 9 is a schematic sectional view of a tab for a short circuit according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

In the present disclosure, layers and regions illustrated in the drawings may be exaggerated in size and relative size for the clarity of the description. For example, the sizes illustrated in the drawings are merely for the sake of convenience and are not limited thereto. Throughout the specification, the same reference signs may denote the same components.

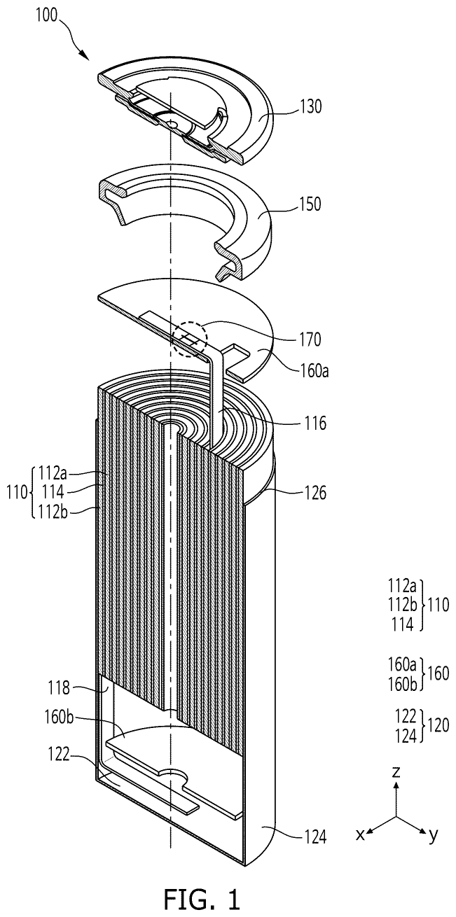

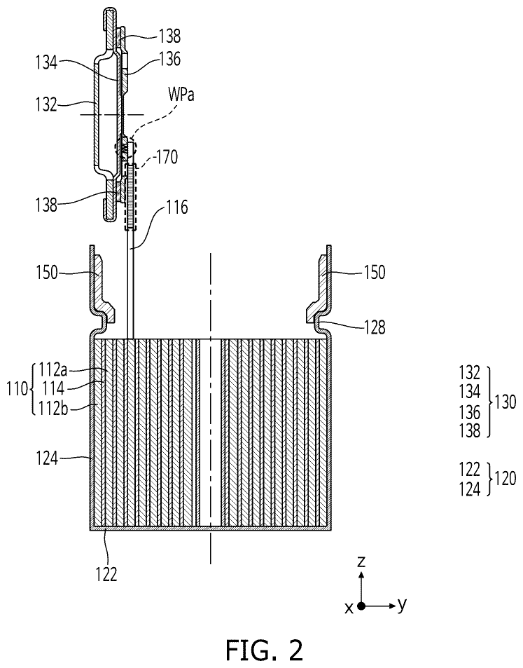

FIG. 1 is an exploded perspective view of a part of a secondary battery according to an embodiment of the present disclosure. FIG. 2 is a longitudinal sectional view of a secondary battery according to an embodiment of the present disclosure before a cap assembly is assembled. FIG. 2 is a diagram in which a first lead tab 116 according to an embodiment is connected to a cap assembly 130 in a secondary battery 100 illustrated in FIG. 1. FIG. 2 illustrates steps before the cap assembly 130 is assembled into a can.

Referring to FIG. 1, the secondary battery 100 according to an embodiment of the present disclosure may include an electrode assembly 110, a can 120, the cap assembly 130, the first lead tab 116, and a second lead tab 118. The can 120 accommodates the electrode assembly 110 and has one end 126 that is open, and the cap assembly 130 may be coupled to the open end 126 of the can 120.

The electrode assembly 110 may include a first electrode 112a, a second electrode 112b, and a separator 114 interposed between the first electrode 112a and the second electrode 112b. The electrode assembly 110 may be a wound electrode assembly (jelly-roll) in which the first electrode 112a, the separator 114, and the second electrode 112b are sequentially stacked and then wound. In other embodiments, the electrode assembly 110 may be a stacked electrode assembly in which units of the first electrode 112a, the separator 114, and the second electrode 112b are sequentially stacked are stacked. But the present disclosure is not limited to wound or stacked configuration. The separator 114 prevents a short circuit by separating the first electrode 112a and the second electrode 112b. The separator 114 may be made of, for example, a polyethylene film, a polypropylene film, a polyethylene-polypropylene film, or the like. The first electrode 112a, the second electrode 112b, and the separator 114 may be in the form of a sheet or a thin film, and sizes thereof are not limited in the present disclosure.

The first electrode 112a may include a first base member and a first active layer provided on the first base member. The first lead tab 116 according to an embodiment of the present disclosure may extend outward from a first uncoated portion of the first base member where the first active layer is not provided. The first lead tab 116 may be electrically connected to the cap assembly 130.

The second electrode 112b may include a second base member and a second active layer positioned on the second base member. The second lead tab 118 may extend outward from a second uncoated portion of the second base member where the second active layer is not provided. The second lead tab 118 may be electrically connected to the can 120. The first lead tab 116 and the second lead tab 118 may extend in directions opposite as illustrated in FIG. 1.

The first lead tab 116 and the second lead tab 118 may integrally extend from the first uncoated portion and the second uncoated portion, respectively, as described above. In other embodiments, the first lead tab 116 and the second lead tab 118 may be separately connected to the first uncoated portion and the second uncoated portion.

The first electrode 112a may function as a positive electrode. In an embodiment, the first base member may be made of aluminum foil. The first active layer may contain, for example, a transition metal oxide. The second electrode 112b may function as a negative electrode. In an embodiment, the second base member may be made of, for example, copper foil or nickel foil, and the second active layer may contain, for example, graphite.

The can 120 may form an outer shape of the secondary battery 100 together with the cap assembly 130, and the can 120 may generally be cylindrical. but the present disclosure is not limited to this shape. However, for convenience, in the present disclosure an example in which the secondary battery 100 is a cylindrical battery will be given.

Referring to FIG. 1, the can 120 may include a body portion 124 with the open end 126 and a bottom portion 122 connected to the body portion 124. The can 120 may accommodate the electrode assembly 110 and an electrolyte therein. For example, the can 120 may include the body portion 124 having a roughly cylindrical shape and the bottom portion 122 connected to one side (for example, a lower side) of the body portion 124. The other side (for example, an upper side) of the body portion 124 may be an open side, and the electrode assembly 110 may enter through the opening and may be accommodated inside the can 120. The can 120 may be made of, for example, nickel-plated iron.

Referring to FIG. 2, the can 120 may further include a beading portion 128 formed in a region between the open end 126 of the body portion 124 and the electrode assembly 110. The beading portion 128 is convexly deformed toward an inside of the body portion 124 and may be positioned closer to the opening of the can 120 than the electrode assembly 110. Although not illustrated, a crimping portion may be positioned closer to the opening of the can 120 than the beading portion 128. The crimping portion may be an edge portion on the open side of the can 120 bent toward the inside of the body portion 124.

The secondary battery 100 may further include gaskets 150 located between the cap assembly 130 and the electrode assembly 110. The beading portion 128 may prevent movement of the electrode assembly 110 inside the can 120 and may facilitate the mounting of the gaskets 150 and the cap assembly 130. The crimping portion may fix the cap assembly 130 by pressing edges of the cap assembly 130 through the gaskets 150. As illustrated in FIG. 2, the gaskets 150 may be located on an upper side of the beading portion 128 and the cap assembly 130 may be assembled and fixed.

The cap assembly 130 may be fixed to the inside of the crimping portion through the gaskets 150 to thereby seal the can 120. Referring to FIG. 2, the cap assembly 130 may include an upper cap 132, a vent portion 134, a lower cap 136, and an insulating layer 138. But the present disclosure is not limited to this configuration and various alternatives are possible.

Referring to FIG. 2, the upper cap 132 may be positioned at an uppermost end of the cap assembly 130. The upper cap 132 may include a terminal portion that protrudes convexly upward to be connected to an external circuit. A discharge port for discharging gas may be positioned around the terminal portion.

The vent portion 134 may be positioned below the upper cap 132. The vent portion 134 may protrude convexly downward and may include at least one notch around the protruding portion. When gas is generated, for example, due to overcharging or abnormal activation of the secondary battery 100, the protruding portion of the vent portion 134 may be deformed upward by the gas pressure, and the vent portion 134 may be cut along the notch. The cut vent portion 134 may prevent an explosion of the secondary battery 100 by releasing gas to outside of the secondary battery 100.

The lower cap 136 may be positioned below the vent portion 134. The lower cap 136 may have a first opening for exposing the protruding portion of the vent portion 134 and a second opening for discharging gas. The insulating layer 138 may be in an outer region between the vent portion 134 and the lower cap 136 to insulate the vent portion 134 and the lower cap 136.

The first lead tab 116 may be connected to the first electrode 112a of the electrode assembly 110 described above and may be coupled to the cap assembly 130. Accordingly, the upper cap 132, the vent portion 134, and the lower cap 136 may be electrically connected to the second electrode 112b of the electrode assembly 110. The cap assembly 130 may thereby function as the first electrode 112a, for example, a positive electrode.

The first lead tab 116 may be connected to a lower surface of the cap assembly 130 (in the assembled secondary battery 100) as illustrated in FIG. 2. In other embodiments, the first lead tab may be connected to the lower cap 136 of the cap assembly 130. One end of the first lead tab 116 may be connected to the electrode assembly 110 and the other end may be connected to the lower surface of the cap assembly 130 or a lower surface of the lower cap 136. A coupling site WPa where such a connection is made is as illustrated in FIG. 2. The coupling may be made by laser welding, ultrasonic welding, or resistance welding. As illustrated in FIG. 2, the first lead tab 116 may overlap with the cap assembly 130 and may be then welded in a direction from the first lead tab 116 toward the cap assembly 130.

Referring to FIG. 1, the second lead tab 118 may be connected to the second electrode 112b of the electrode assembly 110 and may be connected to an inner surface of the bottom portion 122 of the can 120. Accordingly, the can 120 may be electrically connected to the second electrode 112b and may function as the second electrode 112b, in particular, as a negative electrode.

Referring to FIGS. 1 and 2, the first lead tab 116 may have a fuse tab 170 inserted in a middle part of the first lead tab 116. The fuse tab 170 may provide a fuse function by cutting off an overcurrent flow, which thereby prevents thermal runaway and/or a fire. The fuse tab 170 may be inserted in the middle of the first lead tab 116 and correspond to the same size as the first lead tab 116. The specific configuration of the fuse tab 170 will be below.

Referring to FIG. 1, in one embodiment, the first lead tab 116 described above may be bent to be mounted on an upper side of the electrode assembly 110 (for example, an upper surface of the electrode assembly 110) and the fuse tab 170 may be inserted into a portion of the first lead tab positioned on the electrode assembly 110. One end of the first lead tab 116 may be connected to the first electrode 112a of the electrode assembly 110, and the other end of the first lead tab 116 may be connected to a lower end of the cap assembly 130. The first lead tab 116 may be bent, for example, toward a core of the electrode assembly 110 in a region where the first lead tab begins to extend from the upper surface of the electrode assembly 110. In one embodiment, the fuse tab 170 is provided in a region between the bent portion of the first lead tab 116 and the other end of the first lead tab 116 connected to the lower end of the cap assembly 130.

Referring to FIG. 1, the secondary battery 100 may further include an insulating plate 160a located between a portion of the first lead tab 116 mounted on the upper side of the electrode assembly 110 and the electrode assembly 110. The insulating plate 160a may prevent a short circuit between the first lead tab 116 and the second electrode 112b. According to one embodiment, the fuse tab 170 may be mounted on an upper surface of the insulating plate 160. In such a case, a surface of the fuse tab 170 contacts the insulating plate 160, and the other surface may contact with the lower end of the cap assembly 130 or a lower end of the lower cap 136. The other surface of the fuse tab 170 may or may be provided at the coupling site WPa where there is a connection to the lower end of the cap assembly 130 by welding or the like. For example, the fuse tab 170 may be located in a region outside the coupling site WPa of the first lead tab 116, or the coupling site WPa may be positioned on the fuse tab 170. However, when the coupling site WPa is positioned on the fuse tab 170, the coupling site may be positioned on a first metal foil to be described below.

Referring to FIG. 1, the insulating plate 160 may include an upper insulating plate 160a and a lower insulating plate 160b. The upper insulating plate 160a may be positioned between the portion of the first lead tab 116 that is mounted on the upper side of the electrode assembly 110 and the electrode assembly 110. The lower insulating plate 160b may be an insulating plate positioned between the portion of the second lead tab 118 that is located on a lower side of the electrode assembly 110 and the electrode assembly 110.

The first lead tab 116 may be mounted on the upper side of the electrode assembly 110 by extends through a through-hole formed in the upper insulating plate 160a. In other embodiments, the first lead tab may be mounted on the upper side of the electrode assembly 110 by extending through an open space at an edge of the upper insulating plate 160a. The first lead tab 116 may be bent at a portion passing through the through-hole or at a portion passing through the open space. The second lead tab 118 may be located on the lower side of the electrode assembly 110 by passing through a through-hole formed in the lower insulating plate 160b or through an open space at an edge of the lower insulating plate 160b. The second lead tab 118 may be bent at a portion passing through the through-hole or at a portion passing through the open space.

The fuse tab 170 may be provided as a part of the second lead tab 118. In the present disclosure, an example in which the fuse tab 170 is a part of the first lead tab 116 is given, but the present disclosure is not limited thereto. A position, a size, and the like of the fuse tab 170 when the fuse tab is a part of the second lead tab 118 may be substantially identical to the description given above in a case where the fuse tab is a part of the first lead tab. For example, the fuse tab 170 may be provided to a portion of the second lead tab 118 located on the lower side of the electrode assembly 110.

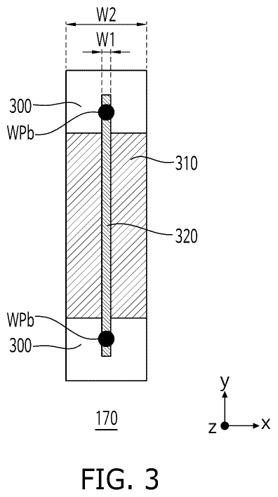

FIG. 3 is a schematic top view of the fuse tab according to an embodiment of the present disclosure. Referring to FIG. 3, the fuse tab 170 according to one embodiment of the present disclosure may include a pair of first metal foils 300, a second metal foil 310 located between the pair of first metal foils 300, and a wire 320 electrically connecting the pair of first metal foils 300 and located on the first metal foils 300 and the second metal foils 310. An insulating member may be included to insulate the first metal foils 300 and the second metal foil 310 and to insulate the wire 320 and the second metal foil 310. The insulating member will be described below.

In one embodiment, the first metal foils 300 may be made of a material that is the same as the metal foil forming the first lead tab illustrated in FIGS. 1 and 2. For example, a portion of the first lead tab other than the portion into which the fuse tab 170 is inserted and all the first metal foils 300 of the fuse tab 170 may be made of aluminum foil. A thickness and a width of the first metal foils 300 may be may correspond to the thickness and width of the first lead tab. In one embodiment, the fuse tab 170 may be part of the first lead tab.

Referring to FIG. 3, the second metal foil 310 may be located between the pair of first metal foils 300. The thickness and width of the second metal foil 310 may correspond to the thickness and width of the first metal foils 300. The first metal foils 300 and the second metal foil 310 may be made of metal, and the material of the first metal foils 300 may be different from the material of the second metal foil 310. In some embodiments, the first metal foils 300 may include any one of aluminum (Al), stainless steel (SUS), iron (Fe), or a combination thereof.

The wire 320 may electrically connect the pair of first metal foils 300 and may be located on the pair of first metal foils 300 and the second metal foil 310. The material of the wire 320 may be different from the material of the second metal foil 310. The wire 320 may be made of metal and may be a conducting wire through which current flows. The first metal foils 300 and the second metal foil 310 may be insulated, and the pair of first metal foils 300 may be electrically conducted through the wire 320. The wire 320 may also be insulated from the second metal foil 310. The wire 320 may transfer heat to the first metal foils 300 and the second metal foil 310.

A coefficient of thermal expansion (CTE) of the second metal foil 310 may be greater than a coefficient of thermal expansion of the wire 320. In one embodiment, a difference between the coefficients of thermal expansion of the wire 320 and the second metal foil 310 may be significantly large. The difference between the coefficients of thermal expansion may mean that a distance between the pair of first metal foils 300 gradually increases due to thermal expansion of the second metal foil 310 such that the wire 320 connecting the pair of first metal foils 300 is cut. In some embodiments, the second metal foil 310 may include any one of zinc (Zn), lead (Pb), magnesium (Mg), or a combination thereof. The material of the wire 320 may be identical to or different from the material of the first metal foils 300. The wire 320 may be aluminum (Al) or copper (Cu). A coefficient of thermal expansion of zinc is about 30×10⁻⁶/° C. to 35×10⁻⁶/° C., a coefficient of thermal expansion of lead may be about 29.3×10⁻⁶/° C., a coefficient of thermal expansion of magnesium is about 25×10⁻⁶° C. to 26×10⁻⁶/° C., a coefficient of thermal expansion of aluminum is about 22×10⁻⁶/° C. to 23×10⁻⁶/° C. depending on a degree of alloying, a coefficient of thermal expansion of iron is about 11.8×10⁻⁶/° C., a coefficient of thermal expansion of stainless steel is about 10×10⁻⁶/° C. to 17×10⁻⁶/° C. depending on a degree of alloying, and a coefficient of thermal expansion of copper is about 16.5×10⁻⁶/° C. to 17.0×10⁻⁶/° C.

According to some embodiments of the present disclosure, combinations of the material of the wire 320 and material of the second metal foil 310 include aluminum and zinc, aluminum and lead, aluminum and magnesium, copper and zinc, copper and lead, copper and magnesium, and the like.

Referring to FIG. 3, the wire 320 may be located along a longitudinal direction (y direction) of the fuse tab 170 and may be coupled to the pair of first metal foils 300 at ends of the wire 320 in the longitudinal direction (y direction). Thus, the wire 320 may be fixed on the metal foils. The coupling between the wire 320 and the metal foils may be performed by laser welding, ultrasonic welding, or resistance welding. The coupling site WPb may be at any part of a region where the wire 320 overlaps the first metal foils 300.

When the first metal foils 300 are made of aluminum, the coupling at WPb may be made by laser welding or ultrasonic welding. When the first metal foils 300 are made of stainless steel or iron, the coupling at WPb may be made by resistance welding. The laser welding may achieve a faster coupling speed than ultrasonic welding.

As illustrated in FIG. 3, a width W1 of the wire 320 may be less than a width W2 of the fuse tab 170. As a result, a current flowing through the first lead tab flows through the wire 320 having a smaller width, and, thus, heat may be concentrated when there is an overcurrent. Accordingly, heat may be transferred to the second metal foil 310 and the current may be cut off more quickly.

The wire 320 may be located on at least one of the surfaces of the metal foil. In such a configuration, a surface on which the wire 320 is located may be an upper surface or a lower surface with respect to the secondary battery illustrated in FIG. 1.

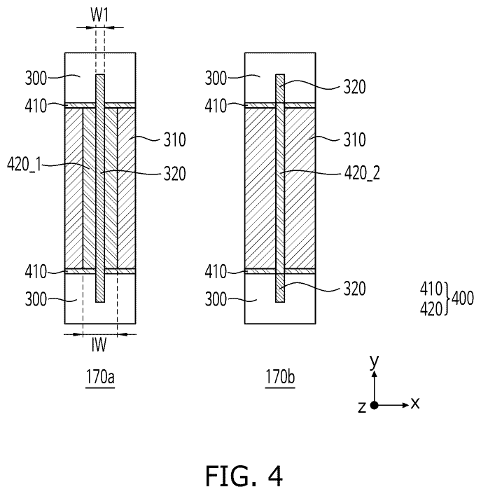

FIG. 4 is a diagram illustrating a position of the insulating member shown in FIG. 3. In particular, FIG. 4 are top views of fuse tabs according to embodiments of the present disclosure.

An insulating member 400 of a fuse tab 170a may insulate the first metal foils 300 and the second metal foil 310, and may insulate the wire 320 and the second metal foil 310. For example, the insulating member 400 may include first insulating members 410 provided between the first metal foils 300 and the second metal foil 310, and a second insulating member 420_1 provided between the wire 320 and the second metal foil 310. As a result, the wire 320 and the first metal foils 300 may be electrically connected to each other. The insulating member 400 provided to the first metal foils 300 and the second metal foil 310 in the form of a thin film or film. A width IW of the second insulating member 420_1 may be greater than the width of the wire 320. For example, the width IW of the second insulating member 420_1 may be about twice the width of the wire 320, but the present disclosure is not limited thereto. In this case, the width means the x direction shown in FIG. 4. As a result, the wire 320 and the second metal foil 310 may be completely insulated, and, thus, a current may flow along the wire 320.

The insulating member 400 of a fuse tab 170b may include first insulating members 410 provided between the first metal foils 300 and the second metal foil 310 and a second insulating member 420_2 surrounding the wire 320. For example, the second insulating member 420_2 may surround only a circumference of the wire 320 located on the second metal foil 310. The insulating member 400 may be coated on the first metal foils 300, the second metal foil 310, and the wire 320. Accordingly, the wire 320 and the first metal foils 300 may be electrically conducted, and a current may flow along the wire 320 and not the second metal foil 310.

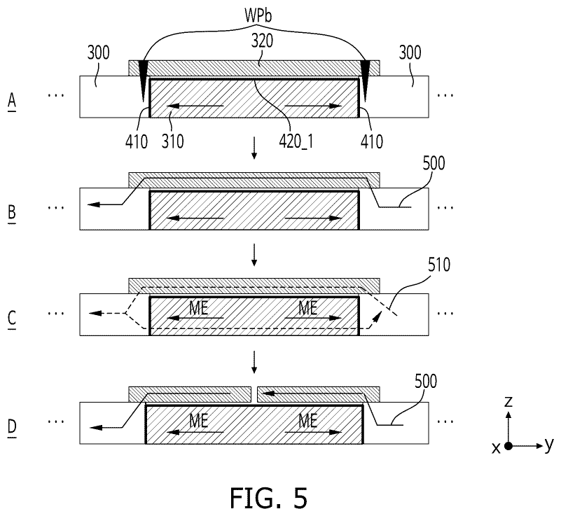

FIG. 5 illustrates an activation procedure of the fuse tab according to an embodiment of the present disclosure. In particular, FIG. 5 illustrates a longitudinal sectional view of the fuse tab.

When the current flowing along the wire 320 is greater than a threshold value, the second metal foil 310 may thermally expand in the longitudinal direction (y direction) of the fuse tab to break the wire 320 that is fixed to the pair of first metal foils 300. The threshold value may vary depending on an electrical circuit of an electronic device or a secondary battery that includes the fuse tab. As such, the threshold value may be a criterion for an overcurrent. Here, overcurrent refers to a situation where more current flows in the electrical circuit than an allowed current, and a criterion for an overcurrent occurrence may be set based on a rated current for the circuit. For example, the overcurrent may be an overload current. The overload current may occur when the current flows continuously beyond a predetermined limit that is outside of a normal range.

The second metal foil 310 may thermally expand in the longitudinal direction (y direction) of the fuse tab at a temperature of 120° C. to 400° C. The wire 320 may not thermally expand at such temperatures or may thermally expand less than the second metal foil 310. For example, in the case of a secondary battery mounted on an electric vehicle, the secondary battery may be designed such that an event such as thermal runaway may be prevented by activating a fuse function due to thermal expansion in the above temperature range.

A timing of current cut-off of the fuse tab according to one embodiment of the present disclosure may vary depending on the difference between the coefficients of thermal expansion of the second metal foil 310 and the wire 320 and the shape of the wire 320. The specific procedure by which the fuse function activates in the fuse tab may be as follows.

An initial state includes the fuse tab A before a current flows, with the wire 320 fixed by welding or the like at the coupling sites on the first metal foils 300. The first metal foils 300 and the second metal foil 310 may be insulated by the first insulating members 410, and the wire 320 and the second metal foil 310 may be insulated by the second insulating member 420_1.

A current flow path 500 in a fuse tab B when a current starts to flow is as illustrated in FIG. 5. The current flow may be formed along the first metal foils 300 and the wire 320 by the insulation provided by the first insulating member 410 and the second insulating member 420_1.

In a fuse tab C, when an overcurrent starts to flow, a heat transfer path 510 for heat generated by current resistance is transferred is as illustrated in FIG. 5. The second metal foil 310 may receive heat from the wire 320 and/or the first metal foils 300. here, the first insulating member 410 and the second insulating member 420_1 may be made of non-insulating materials. Accordingly, temperatures of the first metal foils 300, the second metal foil 310, and the wire 320 may be almost identical to each other. When the temperature of the wire 320 becomes higher than the surroundings due to the overcurrent flowing through the wire 320, heat may be transferred along the heat transfer path 510 illustrated in FIG. 5. Accordingly, the second metal foil 310 having a coefficient of thermal expansion that is greater than the coefficient of thermal expansion of the wire 320 may gradually expand in the longitudinal direction (y direction). For example, the second metal foil 310 may expand in both directions (+y direction and −y direction) in the longitudinal directions or in a metal expansion direction (ME).

As the second metal foil 310 expands in the metal expansion direction (ME), a fuse tab D with the wire 320 is broken as illustrated in FIG. 5. Thus, a current flow in the wire 320 is stopped and the fuse function activation is completed. The wire 320 may be broken by a mechanical force generated as the second metal foil 310 expands due to heat or overcurrent. Since the breakage is caused by a consistent physical response to a defined condition (e.g., thermal expansion), the variation in the timing of wire breakage and the associated electrical disconnection (current cut-off) can be reduced, thereby improving reliability.

Additionally, the second metal foil 310 may have a greater length in the longitudinal (y) direction than that of a fuse tab C in its pre-cut state, as described above, which may allow for more effective stress accumulation and reliable breakage.

The first metal foils 300 on both sides of the second metal foil 310 may be pushed in the metal expansion direction (ME) due to the thermal expansion of the second metal foil 310. The wire 320 may be made of a metal immediately cut by a pulling force at both ends in the longitudinal direction (y direction). For example, the wire may be made of aluminum (Al) or copper (Cu). In one embodiment, the wire 320 may break as soon as a distance between the pair of first metal foils 300 increases due to the thermal expansion of the second metal foil 310. Thus, the current flow need not be cut off due to the melting of the wire 320, but may result from breakage of the wire 320.

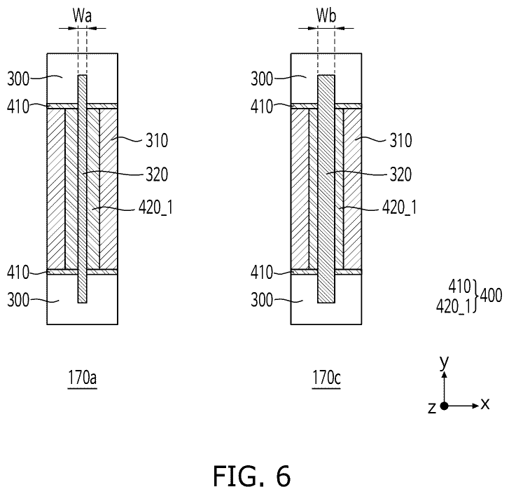

FIG. 6 are top views of fuse tabs according to embodiments of the present disclosure. FIG. 6 shows how time it takes for the wire 320 to break may vary depending on the width of the wire 320. In the present disclosure, cases where the wire 320 has a constant thickness are described as examples. However, the present disclosure is not limited to such examples and both the thickness and the width may be different. When the wire is designed such that the thickness is constant and varies in width, it can be easy to adjust the size of the wire 320. Accordingly, the breaking point of the wire 320 may be adjusted more easily.

A fuse tab 170c according to one embodiment may differ only in the width of the wire 320 compared to the fuse tab 170a according to another embodiment. The sizes and disposition methods (for example, attachment, coating, or the like) of the first insulating members 410 and the second insulating member 420_1 may be substantially identical in two embodiments. Here, the width means the x direction as shown in FIG. 4. A width Wb of the wire 320 of the fuse tab 170c may be wider than a width Wa of the wire 320 of the fuse tab 170a. Thus, the time it takes for the the fuse tab 170c to break resulting from an overcurrent is greater than the time it takes for the fuse tab 170a to break. Accordingly, a current cut-off time may be delayed. As the width of the wire 320 increases, the cutting and current cut-off timings of the wire 320 may be further delayed. Accordingly, the fuse function may be designed by varying the width of the wire 320.

In specific example, when the width of the fuse tab is 4 mm, the width Wb of the wire 320 of the fuse tab 170c may be 2 mm, and the width Wa of the wire 320 of the fuse tab 170a may be 1 mm.

Table 1 shows current cut-off times for fuse tabs with different width wires 320 provided in the first lead tabs of cylindrical batteries. The current cut-off time mean the amount of time (seconds) from\when current starts to flow to when the wire 320 connected to the first metal foils 300 is broken due to the thermal expansion of the second metal foil 310. In these tests, the current intensity was set to about 50 A.

TABLE 1

| | Width of wire | Current cut-off time |
|---|---|---|
| | (mm) | (seconds) |
| Example 1 | 0.5 | 45 |
| Example 2 | 1 | 65 |
| Example 3 | 2 | 68 |
| Example 4 | 3 | 73 |
| Example 5 | 4 | 82 |

As shown in Table 1, as the width of the wire 320 increases, the current cut-off time becomes longer. The current cut-off timing of the fuse tab may be adjusted a specific width of the wire 320 per the profile for current cut off times shown in Table 1.

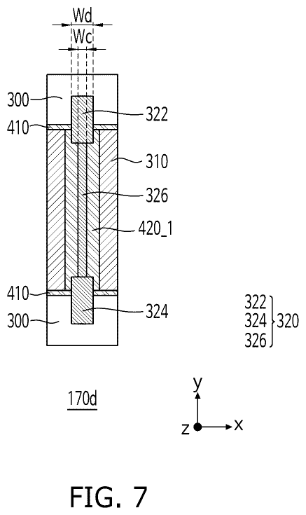

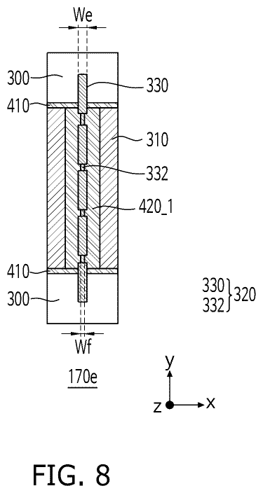

FIGS. 7 and 8 are schematic top views of fuse tabs according embodiments of the present disclosure. FIG. 7 and FIG. 8 illustrate cases where the shapes of wires 320 are different in the fuse tab illustrated in FIG. 6. Here, the width means a length in the x direction as shown in FIGS. 7 and 8.

Referring to FIG. 7, a wire 320 of a fuse tab 170d according may include a first coupling portion 322, a second coupling portion 324, and a connecting portion 326 connecting the first coupling portion 322 and the second coupling portion 324. The first coupling portion 322 and the second coupling portion 324 may be coupled to the first metal foils 300, and the connecting portion 326 may be located on the second metal foil 310. The first coupling portion 322 or the second coupling portion 324 may be located on each of the first insulating member s410, the second insulating member 420_1, and the first metal foils 300, but the present disclosure is not limited thereto The wire 320 may be fixedly connected between the first coupling portion 322 and one of the first metal foils 300 and the second coupling portion 324 and the other one of the first metal foils 300.

A width Wc of the connecting portion 326 may be less than a width Wd of the first coupling portion 322 or the second coupling portion 324. For example, the width of the connecting portion 326 may be 1 mm, and each of the widths of the first coupling portion 322 and the second coupling portion 324 may be 3 mm.

Referring to FIG. 8, a wire 320 of the fuse tab 170e according to another embodiment includes first wires 330 and second wires 332 having different widths. In particular, a width Wf of the second wire 332 may be less than a width We of the first wire 330. In an embodiment, the first wires 330 and the second wires 332 are located alternately, but both ends of the wire 320 in a length direction may be provided to the first wires 330. The first wires 330 at both ends may be located on the first insulating members 410 and the first metal foils 300 as illustrated in FIG. 8, but the present disclosure is not limited thereto, and the first wires 330 may be located only on the first metal foils 300. However, the coupling may be performed between the first wire 330 and the first metal foils 300, and, thus, the wire 320 may be fixed.

The width Wf of the second wire 332 may be 0.5 mm, and the width We of the first wire 330 may be 1 mm. A breaking point and a breaking of the wire 320 may be adjusted by adjusting the width and thickness of the wire 320 or by adjusting the structure of the wire 320 having multiple widths.

Table 2 shows current cut-off times for fuse tabs having different-shaped wires 320 as determined by an evaluation method substantially identical to the evaluation method described above. The width (mm) of the wire 320 is expressed as a long width or a short width. Example 6 illustrates the evaluation result for the fuse tab 170d depicted in FIG. 7, and Example 7 illustrates the evaluation result for the fuse tab 170e depicted in FIG. 8.

TABLE 2

| | Width of wire | Current cut-off time |
|---|---|---|
| | (mm) | (seconds) |
| Example 6 | 3/1 | 70 |
| Example 7 | 1/0.5 | 50 |

As demonstrated by the results shown in Table 2, the shorter a width of a thinnest portion of the wire 320, the shorter the breaking time. A shorter current cut-off time means that the wire 320 is broken and the current is cut-off even at a lower temperature. In the case of Example 6, the breaking occurred at the connecting portion 326, and in the case of Example 7, the breaking occurred at the second wire 322.

In addition to the width or thickness of the wire 320 through which the current flows, the current cut-off time may also vary depending on tensile strength, elongation, or the like of the wire 320. The tensile strength refers to a maximum load with which metal withstands without breaking when tension is applied to metal. The elongation is a value obtained by measuring ability of metal to stretch under tensile force and indicates ductility of metal. As the tensile strength of the wire 320 increases, the current cut-off time may increase. In other embodiments, a higher elongation of the wire 320 may increase the current cut-off time.

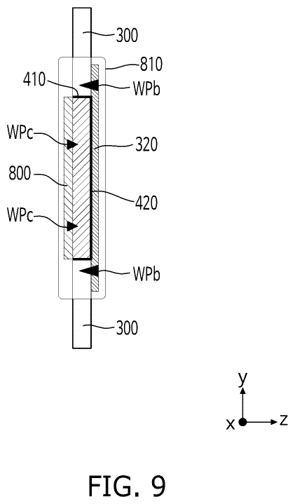

FIG. 9 is a view of a tab for a short circuit according to one embodiment of the present disclosure. In particular, FIG. 9 is a longitudinal sectional view of a fuse tab in which a third metal foil 800 and a cover 810 are included.

As illustrated in FIG. 9, the fuse tab may further include the third metal foil 800 coupled to a lower end of the second metal foil 310. A coefficient of thermal expansion of the third metal foil 800 may be greater than a coefficient of thermal expansion of the second metal foil 310. As a result, when the second metal foil 310 does not smoothly expand, the second metal foil 310 may be guided by the third metal foil 800, and accordingly, the wire 320 may break.

Ehen the current flowing along the wire 320 exceeds a threshold value or when overcurrent flows, the third metal foil 800 may thermally expand in the longitudinal direction (y direction) of the fuse tab to the wire 320. Tension that pulls the second metal foil 310 and the wire 320 to both sides may be increased by the thermal expansion of the third metal foil 800.

Referring to FIG. 9, the third metal foil 800 may be coupled to the second metal foil 310 by welding or the like. At a coupling site WPc, the third metal foil 800 may be connected to the second metal foil 310, and when the third metal foil 800 thermally expands, the connected second metal foil 310 may also expand. As a result, the wire 320 may break in the event of an overcurrent, and thus, the fuse function may be activated. When the third metal foil 800 is added, the reliability of the current cut-off due to the expansion of the second metal foil 310 may be further improved.

Referring to FIG. 9, the cover 810 may seal a part of the first metal foils 300, the second metal foil 310, and the third metal foil 800. A shape of the cover 810 is not limited but may cover at least the wire 320 and the second metal foil 310. In other embodiments, the cover may cover at least the wire 320, the second metal foil 310, and the third metal foil 800. The cover 810 protect the components from the internal environment of the secondary battery and prevent impact to the components. As a result, the fuse function may be maintained. The cover may also prevent electrical connection with other components. The cover 810 may be made of an insulating material. For example, the cover 810 may contain polyimide, polycarbonate, epoxy resin, silicone, or polytetrafluoroethylene.

Although the present disclosure has been described above with respect to embodiments thereof, the present disclosure is not limited thereto. Various modifications and variations can be made thereto by those skilled in the art within the spirit of the present disclosure.

DESCRIPTION OF SOME REFERENCE SYMBOLS

100: secondary battery
110: electrode assembly
112a: first electrode
112b: second electrode
114: separator
116: first lead tab
118: second lead tab
120: can
122: bottom portion
124: body portion
126: one end
130: cap assembly
150: gasket
160: insulating plate
170: fuse tab

1. A fuse tab comprising:
a pair of first metal foils;
a second metal foil located between the first metal foils;
a wire electrically connecting the first metal foils and located on the first metal foils and the second metal foil; and
an insulating member insulating between the first metal foils and the second metal foil and insulating between the wire and the second metal foil,
wherein a material of the first metal foils is different from a material of the second metal foil,
wherein a material of the wire is different from the material of the second metal foil, and
wherein a coefficient of thermal expansion of the second metal foil is greater than a coefficient of thermal expansion of the wire.

2. The fuse tab as claimed in claim 1, wherein the wire is located along a longitudinal direction of the fuse tab and is coupled to the first metal foils at opposite ends of the wire in a longitudinal direction.

3. The fuse tab as claimed in claim 1, wherein the fust tab is configured such that when a current flowing along the wire is greater than or equal to a threshold value, the second metal foil thermally expands in a longitudinal direction of the fuse tab to thereby break the wire.

4. The fuse tab as claimed in claim 1, wherein a width of the wire is less than a width of the fuse tab.

5. The fuse tab as claimed in claim 2, wherein the wire comprises a first coupling portion, a second coupling portion, and a connecting portion connecting the first coupling portion and the second coupling portion,
wherein the first coupling portion and the second coupling portion are coupled to the first metal foils, and the connecting portion is provided on the second metal foil, and
wherein a width of the connecting portion is less than a width of the first coupling portion or the second coupling portion.

6. The fuse tab as claimed in claim 1, wherein the wire includes first wires and second wires, with widths of the first wires being different than widths of the second wires,
wherein a width of the second wire is less than a width of the first wire, and
wherein the first wires and the second wires alternate in a longitudinal direction of the wire, and one of the first wires are provided at ends of the wire in the longitudinal direction.

7. The fuse tab as claimed in claim 1, wherein the insulating member comprises first insulating members positioned between the first metal foil and the second metal foil, and a second insulating member positioned between the wire and the second metal foil, and
wherein a width of the second insulating member is greater than a width of the wire.

8. The fuse tab as claimed in claim 1, wherein the insulating member comprises first insulating members coated between the first metal foils and the second metal foil, and a second insulating member coated around the wire, and
wherein the second insulating member surrounds a circumference of the wire that is located on the second metal foil.

9. The fuse tab as claimed in claim 1, further comprising:
a third metal foil coupled to a lower end of the second metal foil,
wherein a coefficient of thermal expansion of the third metal foil is greater than a coefficient of thermal expansion of the second metal foil.

10. The fuse tab as claimed in claim 9, wherein the fuse tab is configured such that when a current flowing along the wire is greater than or equal to a threshold value, the third metal foil thermally expands in a longitudinal direction of the fuse tab to thereby break the wire.

11. A secondary battery comprising:
an electrode assembly comprising a first electrode, a second electrode, and a separator interposed between the first electrode and the second electrode;
a can accommodating the electrode assembly and having an open end;
a cap assembly sealing the open end of the can;
a first lead tab connected to the first electrode of the electrode assembly and coupled to the cap assembly;
a second lead tab connected to the second electrode of the electrode assembly; and
a fuse tab provided in the middle of the first lead tab,
wherein the fuse tab comprises:
a pair of first metal foils,
a second metal foil located between the first metal foils,
a wire electrically connecting the first metal foils and located on the first metal foils and the second metal foil, and
an insulating member insulating between the first metal foils and the second metal foil and insulating between the wire and the second metal foil,
wherein a material of the first metal foils is different from a material of the second metal foil,
wherein a material of the wire is different from a material of the second metal foil, and
wherein a coefficient of thermal expansion of the second metal foil is greater than a coefficient of thermal expansion of the wire.

12. The secondary battery as claimed in claim 11, wherein the wire is located along a longitudinal direction of the fuse tab and is coupled to the first metal foils at opposite ends of the wire in a longitudinal direction.

13. The secondary battery as claimed in claim 11, wherein the fust tab is configured such that when a current flowing along the wire is greater than a threshold value, the second metal foil thermally expands in a length direction of the fuse tab to thereby cut the wire.

14. The secondary battery as claimed in claim 11, wherein the first lead tab is bent and mounted on an upper side of the electrode assembly, and the fuse tab is positioned on the electrode assembly.

15. The secondary battery as claimed in claim 14, further comprising:
an insulating plate located between a portion of the first lead tab mounted to the upper side of the electrode assembly and the electrode assembly,
wherein an end of the first lead tab is connected to a lower end of the cap assembly.

16. The secondary battery as claimed in claim 13, wherein the fuse tab is configured such that when a current flowing along the wire and the first metal foils is greater than a threshold value, the second metal foil thermally expands in a longitudinal direction of the fuse tab due to heat transferred from the wire and the first metal foils.

17. The secondary battery as claimed in claim 16, wherein the second metal foil is configured to expand in the longitudinal direction of the fuse tab at a temperature of 120° C. to 400° C.

18. The secondary battery as claimed in claim 11, wherein the first metal foils comprise aluminum, stainless steel, iron, or a combination thereof.

19. The secondary battery as claimed in claim 11, wherein the second metal foil comprises zinc, lead, magnesium, or a combination thereof.

20. The secondary battery as claimed in claim 11, wherein the secondary battery is a cylindrical battery.
